(19) United States
(12) Patent Application Publication
(10) Pub. No.: US 2022/0061420 A1
(43) Pub. Date: Mar. 3, 2022

(54) Dustproof and Antibiotic Mask Using Metal Microfilament Fabric

(71) Applicant: Chang Su LEE, Namyangju-si (SK)

(72) Inventor: Chang Su LEE, Namyangju-si (SK)

(21) Appl. No.: 16/953,169

(22) Filed: Nov. 19, 2020

(30) Foreign Application Priority Data
Aug. 28, 2020 (KR) 10-2020-0109077

(51) Int. Cl. A41D 13/11; A62B 18/02; A62B 23/02

(52) U.S. Cl. CPC A41D 13/1115; A62B 23/02; A62B 18/025

(57) ABSTRACT

A non-woven cloth mask including a metal filament having a diameter of 20-100 μm is manufactured from a metal selected from the group consisting of silver, silver alloy, copper, or copper alloy. The metal microfiber cloth of a plain weave structure is woven by using the metal filament as a weft yarn and a warp. The metal microfiber cloth is of a plain weave fabric woven from a metal filament having a diameter 20 to 100 μm manufactured from a metal selected from the group consisting of silver, silver alloy, copper, or copper alloy. The metal microfiber cloth is preferably 50 to 70% of the area of the front cover, and fixed to the front cover by stitching or high-frequency heating.

### TECHNICAL FIELD

The present invention relates to a mask. More specifically, the present invention relates to a mask having a dustproof and antibiotic function using a metal microfiber cloth for protection from air pollution such as fine dust and yellow dust as well as pathogens such as SARS virus, MERS virus, and coronavirus.

### BACKGROUND

The coronavirus (Corona-19) outbreak in Wuhan, China at the end of 2019, has reached a situation where it is declared a pandemic worldwide in the first half of 2020. In the second half of 2020, the number of Corona-19 patients is rapidly increasing, and the number of deaths is also increasing steeply. Experts are warning the risk of the second or third pandemic of Corona-19 in the future.

Masks have become a necessity for people around the world as one of the most powerful prevention measures in the pandemic situation caused by Corona-19. Beyond the conventional dust-proof function to protect people from air pollution such as fine dust and yellow dust, the need for a mask that blocks droplets containing various viruses and further has a sterilizing function has emerged.

In Korea, masks with performance standards such as KF80 and KF94 are commonly used, which are mask standards for the prevention of new influenza prepared by the Ministry of Food and Drug Safety, and represent masks with a dust collecting efficiency of not less than 80%, or not less than 94%. However, these masks only capture and block pathogens such as contaminants and viruses, and do not have the function of killing the pathogens. Therefore, masks having antibacterial or sterilizing functions are being developed in various ways.

Korean Patent Publication No. 2004-0106959 discloses a copper fiber sterilization mask constructed by inserting knitted copper finer fabric 3 which is made by weaving knitting at least one or plurality of braided super fine copper fibers with anion fibers in a vertical and horizontal grid form between the inner and outer cloth of the mask.

Korean Patent No. 1061895 discloses an antibacterial mask constructed by inserting mesh of Ag wire between the inner and outer cloth of the mask, wherein the mesh of the Ag wire is manufactured by using at least one of mesh of Ag wire or Ag ply yarn in at least one of warp and weft yarns, wherein the Ag wire of at least one strand is made by casting silver or silver alloy containing copper into a wire rod using a directional solidification method, and by letting the cast wire be molded into microfibers with a diameter of 0.015 to 0.05 mm by a drawing process, and wherein the Ag ply yarn is obtained by covering or adding a fiber yarn made of natural or synthetic fiber to the Ag wire then twisting it.

Korean Patent No. 2108768 discloses an antibiotic mask consisting of an inner cloth, an outer cloth, and a non-woven fabric inserted between the inner cloth and the outer cloth, wherein the non-woven fabric contains copper ion-exchanged illite, and wherein the copper ion content of the copper ion-exchanged illite is increased by 20˜40 percent weight by the copper-ion exchange. Silver and copper are metals with excellent antibiotic or sterilization properties, and it is noted that researches to develop antibiotic or sterilization masks using them has been continued.

Silver has traditionally been used for money (silver and silver alloy coins), medals, jewelry, tableware, and photographs, but nowadays it is used in a larger amount industrially. It is used for a wide variety of uses, such as conducting materials for electronic products or circuits, amalgam for filling cavities, batteries, chemical reaction catalysts, and water purification, antibacterial treatment of fibers, wood, and bandages for wound healing, and is also used to reduce bacterial growth in cell phone cases. Silver ions and silver compounds are highly toxic to some organisms such as bacteria, viruses, algae, and fungi, but have little toxicity to humans, and have been used for antibacterial and antibiotic treatment since ancient times.

Because copper has excellent heat and electrical conductivity, it is widely used in wires, printed circuit boards, heat sinks of electronic devices, heat exchangers, and so on. Because it is not easily corroded, it is used as a material for water pipes and roofing. Because copper and copper compounds have excellent antibacterial properties, they are also used as pesticides to kill pests, antibacterial agents to prevent the growth of fungi, disinfectants for plant seeds, fungicides, and algicides. According to a recent study, as many as 355 copper alloys were found to kill 99.9% of pathogens within 2 hours if cleaned regularly.

The present inventor came to develop the mask of the present invention having an antibacterial and sterilizing function superior to any conventional antibacterial mask by using the above antibacterial properties of silver and copper.

### SUMMARY OF THE INVENTION

### Object of the Invention

It is an object of the present invention to provide a new mask having excellent antibacterial or sterilizing functions while maintaining the dustproof function of the conventional mask.

It is another object of the present invention to provide a mask having excellent antibacterial and sterilizing functions so as to prevent bacterial growth in the mask cloth due to moisture when wearing the mask.

It is still another object of the present invention to provide a new mask capable of prolonging the use time of the mask by preventing the growth of bacteria in the mask cloth.

It is another object of the present invention to provide a metal microfiber cloth for a mask woven a microfiber, wherein the microfiber is made from metals such as copper or silver so as to impart an excellent antibacterial and sterilization function to a mask.

All of the above and other objects of the present invention can be achieved by the present invention described in detail below.

### Technical Solution

The mask according to the present invention is characterized in that a metal filament having a diameter of 20-100 μm is manufactured from the metal selected from the group consisting of silver, silver alloy, copper, or copper alloy, and the metal microfiber cloth of a plain weave structure is woven by using the metal filament as a weft yarn and a warp, and then the a structure in which the metal microfiber cloth is attached to the inside, in the middle, or to the outside of the mask is formed.

A conventional non-woven fabric mask which is currently used comprises a front cover 10 (main body), a upper rear cover 21 foldably attached to the upper edge of the front cover 10, a lower rear cover 22 foldably attached to the lower edge of the front cover 10, and a pair of ear strings attached to the side edges of the front cover 10, wherein a metal wire 40 is inserted in the upper part of the upper rear cover 21 and fixed by a high-frequency heating 41.

The front cover 10 has a triple structure consisting of an inner cloth 11, an outer cloth 13, and a filter cloth 12 inserted between the inner cloth 11 and the outer cloth 13.

The triple structure of the front cover 10 (main body) of the conventional masks has a function to capture and block dust or bacteria. However, the conventional masks do not have the function of killing the captured bacteria. The mask of the present invention comprises a metal microfiber cloth 15 of a plain weave fabric woven from a metal filament having a diameter of 20 to 100 μm manufactured from a metal selected from the group consisting of silver, silver alloy, copper, or copper alloy attached to at least one site of between the inner cloth 11 and the filter 12, the filter 12 and the outer cloth 13, inside of the inner cloth 11, or outside of the outer cloth 13.

The metal microfiber cloth 15 woven in a plain weave is preferably within the range of 100 to 300 per one square inch in the number of warp and weft yarns. The number of filaments per one square inch is preferably about 100 to 300. The metal microfiber cloth 15 is preferably 50 to 70% of the area of the front cover 10 (main body), and fixed to the front cover 10 by stitching or high-frequency heating. Specifically, the metal microfiber cloth 15 may be preferably used in a width of 7 to 12 cm, and a length of 4 to 6 cm.

According to an embodiment, the present invention provides a non-woven cloth mask having a dustproof and antibacterial function, the mask comprising a front cover 10, an upper rear cover 21 which is foldably attached to the upper edge of the front cover, a lower rear cover 22 which is foldably attached to the lower edge of the front cover, and a pair of ear strings 30 which are attached to the side edges of the front cover, wherein the front cover comprises an inner cloth 11, an outer cloth 13, and a filter cloth 12 inserted between the cloths 11 and 13, wherein the mask further comprises g at least one metal microfiber cloth 15 which is inserted between the inner cloth 11 and the filter cloth 12 or between the outer cloth 13 and the filter cloth 12, or attached to the inner surface of the inner cloth 11 or to the outer surface of the outer cloth 13.

According to another embodiment, the present invention provides the mask described above, wherein the metal microfiber cloth 15 is a plain weave fabric which is woven with a metal filament having a diameter of about 20 to 200 μm, wherein the number of filaments per one square inch is about 100 to 300, and wherein the metal is selected from the group consisting of silver, silver alloy, copper and copper alloy.

According to still another embodiment, the present invention provides the mask described above, wherein the metal microfiber cloth has a size of about 50 to 70% of the surface of the front cover 10.

According to another embodiment, the present invention provides the mask described above, wherein the metal microfiber cloth 15 has a width of about 7 to 12 cm and a length of about 4 to 6 cm. According to another embodiment, the present invention provides the mask described above, wherein the metal microfiber cloth 15 is fixed to the front cover 10 by stitching. According to still another embodiment, the present invention provides the mask described above, wherein a wire is inserted into the upper part of the upper rear cover 21 and fixed by high-frequency heating 41.

According to another embodiment, the present invention provides a cotton cloth mask having a dustproof and antibacterial function, the mask comprising an inner cloth 51, an outer cloth 53, and a filter cloth 52 inserted between the cloths 51 and 53, wherein the mask further comprises at least one metal microfiber cloth 15 which is inserted between the inner cloth 51 and the filter cloth 52 or between the outer cloth 53 and the filter cloth 52, or attached to the inner surface of the inner cloth 51 or to the outer surface of the outer cloth 53.

According to another embodiment, the present invention provides the mask described above, wherein the metal microfiber cloth 15 is a plain weave fabric which is woven with a metal filament having a diameter of about 20 to 200 μm, wherein the number of filaments per one square inch is about 100 to 300, and wherein the metal is selected from the group consisting of silver, silver alloy, copper and copper alloy. According to still another embodiment, the present invention provides the mask described above, wherein the metal microfiber cloth 15 has a size of about 50 to 70% of the surface of the front cover 10. According to still another embodiment, the present invention provides the mask described above, wherein the metal microfiber cloth 15 has a width of about 7 to 12 cm and a length of about 4 to 6 cm.

According to another embodiment, the present invention provides the mask described above, wherein the metal microfiber cloth is fixed to the front cover 10 by stitching 54. According to still another embodiment, the present invention provides the mask described above, wherein a wire is inserted into the upper part between the inner cloth 51 and the outer cloth 53 and fixed by stitching.

Hereinafter, the present invention will be described in detail with reference to the accompanying drawings.

### The Effects of the Invention

The present invention manufactures microfibers from metals such as copper or silver, and uses the metal microfiber cloth for masks woven from the microfibers so as to impart superior antibacterial and sterilizing function to the mask, providing an antibacterial and sterilizing mask capable of preventing bacterial growth in the mask cloth due to moisture when wearing a mask.

### BRIEF DESCRIPTION OF THE DRAWINGS

FIG. 1 is a schematic perspective view illustrating a front part of a conventional non-woven mask. FIG. 2 is a schematic perspective view showing a state in which the upper rear cover 21 and the lower rear cover 22 are unfolded in the mask of FIG. 1. FIG. 3 is a schematic diagram showing the structure of the front cover (main body) of the mask of FIG. 1. FIG. 4 is a schematic perspective view of a metal microfiber cloth 15 used in the present invention. FIG. 5 is a schematic perspective view showing a state in which the metal microfiber cloth 15 is inserted into the front cover (main body) 10 and fixed by stitch or high-frequency heating. FIG. 6 is a schematic perspective view showing a state in which the metal microfiber cloth 15 is fixed to the outside of the outer cloth 13 by the stitch 16.

FIG. 7 is a schematic perspective view showing a state in which the metal microfiber cloth 15 is fixed by the stitch 16 inside the inner cloth 11. FIG. 8 is a schematic perspective view of a conventional cotton fabric mask manufactured by a sewing method using a cotton fabric. FIG. 9 is a model diagram showing the configuration of the mask of FIG. 8. FIG. 10 is a schematic perspective view showing that the metal microfiber cloth 15 of the present invention is inserted into the mask of FIG. 8. FIG. 11 is a schematic perspective view showing that the metal microfiber cloth 15 of the present invention is fixed to the mask inner cloth 51 of FIG. 8 by a stitch 54.

### DETAILED DESCRIPTION OF INVENTION

The present invention relates to a mask, and to a mask having a dustproof and antibacterial function using a metal microfiber cloth for protection from air pollution such as fine dust and yellow sand, as well as pathogens such as SARS virus, MERS virus, and coronavirus, etc.

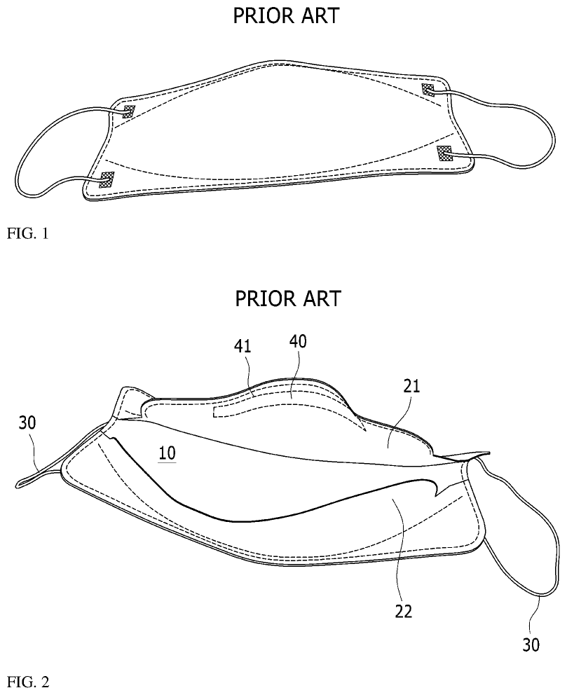

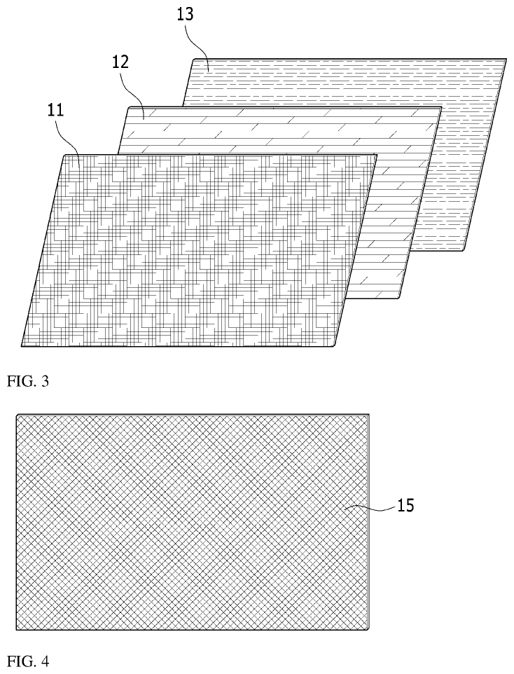

An exemplary non-woven fabric masks commonly used are as shown in FIGS. 1 and 2. FIG. 1 is a schematic perspective view showing a front part of a conventional mask, and FIG. 2 is a schematic perspective view showing a state in which the upper rear cover 21 and the lower rear cover 22 are unfolded in the mask of FIG. 1. This mask comprises a front cover 10 (main body), an upper rear cover 21 foldably attached to the upper edge of the front cover 10, a lower rear cover 22 foldably attached to the lower edge of the front cover 10, and a pair of ear strings attached to the side edges of the front cover 10.

This mask is the most common structure that is automatically and continuously manufactured by a mask manufacturing apparatus. A metal wire 40 is inserted in the upper part of the upper rear cover 21 and fixed by a high-frequency heating 41. The front cover 10 (main body) has a triple structure consisting of an inner cloth 11, an outer cloth 13, and a filter cloth 12 inserted between the inner cloth 11 and the outer cloth 13. FIG. 3 is a schematic exploded perspective view showing the structure of a front part (main body) of a conventional mask. It is classified as KF80, KF94, KF98, and the like, according to the performance of the filter 12. The triple structure of the front cover 10 (main body) of the conventional masks has a function to capture and block dust or bacteria.

However, the conventional masks do not have the function of killing the captured bacteria.

The mask of the present invention is characterized in that a fabric woven with metal filaments containing silver or copper components is inserted into the mask or attached to the outer or inner cloth so as to have an antibacterial function as well as a dustproof function.

Specifically, a metal filament having a diameter of 20 to 100 μm is prepared from the metal selected from the group consisting of silver, silver alloy, copper, or copper alloy, and a metal microfiber cloth of a plain weave fabric is woven by using the metal filament as a weft yarn and a warp yarn. Metal filaments are cast from metal materials containing silver or copper into wire rods by a known technique, and microfibers having a desired diameter are produced by drawing the cast wire rods. Copper or a copper alloy may be preferably used, and the copper alloy is preferably a brass containing up to 3 to 30% by weight of zinc.

The metal microfiber cloth 15 woven in a plain weave is preferably within the range of 100 to 300 per one square inch in the number of warp and weft yarns. The number of filaments per one square inch is preferably about 100 to 300. The number of warp and weft yarns is preferably 100 or more per one square inch to have sufficient antibacterial effect. If the number of warp and weft yarns exceeds 300 per one square inch, the fabric is too dense and air permeability is low, therefore breathing is may not be smooth.

Therefore, it is possible to manufacture a mask continuously by an automated machine without any problem in the mask manufacturing process. The metal microfiber cloth 15 of the present invention has the same flexibility as a fabric woven from ordinary fibers, not causing a feeling of uncomfortableness or rejection when wearing a mask.

Metal microfiber cloth 15 may be inserted and attached into at least one of the sites of between the inner cloth 11 and the filter 12, between the filter 12 and the outer cloth 13, inside the inner cloth 11, or outside the outer cloth 13.

FIG. 5 is a schematic perspective view showing a state in which the metal microfiber cloth 15 is inserted into the front cover (main body) 10 and fixed by stitch. It is preferable that the metal microfiber cloth 15 inserted therein corresponds to an area of 50 to 70% of the mask main body 10. Specifically, the metal microfiber cloth 15 may be preferably used with a width of 7 to 12 cm, and a length of 4 to 6 cm. FIG. 4 is a schematic perspective view of a metal microfiber cloth 15 used in the present invention. The stitch is possible by an automated process in the mask manufacturing apparatus, which can be easily implemented by a person skilled in the art to which the present invention belongs.

FIG. 6 is a schematic perspective view showing a state in which the metal microfiber cloth 15 is fixed to the outside of the outer cloth 13 by the stitch 16. The metal microfiber cloth 15 is exposed to the outside in the mask of this embodiment. In this case, the metal microfiber cloth 15 may or may not be inserted into the front cover (main body) 10.

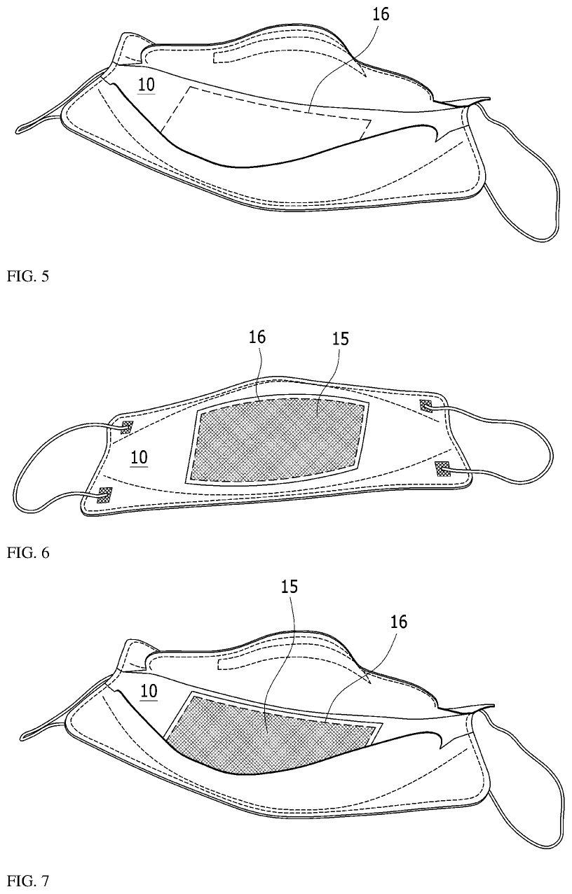

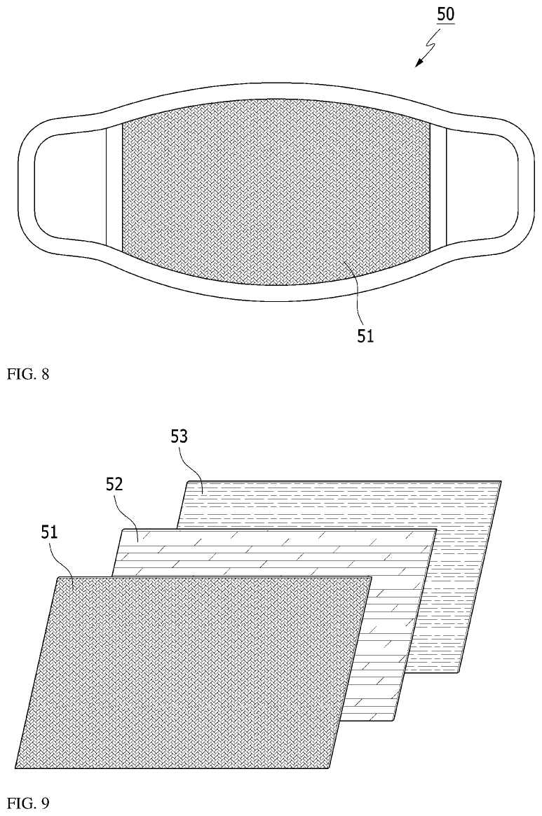

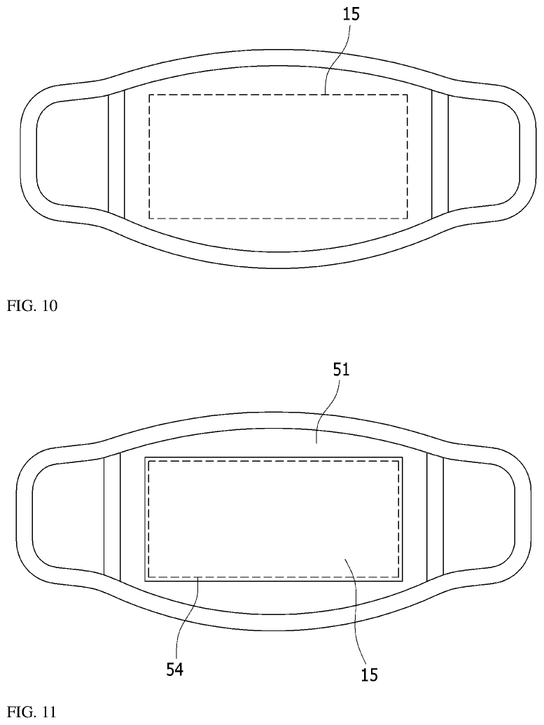

FIG. 7 is a schematic perspective view showing a state in which the metal microfiber cloth 15 is fixed by the stitch 16 inside the inner cloth 11. In the mask of this embodiment, the metal microfiber cloth 15 is in direct contact with the facial skin. However, since the metal microfiber cloth 15 is flexible like a fabric, there is no feeling of rejection or inconvenience. In this case, the metal microfiber cloth 15 may or may not be inserted into the front cover (main body) 10. Optionally, a metal microfiber cloth 15 may be additionally attached to the outside of the outer cloth 13.

All of the masks shown in FIGS. 1 to 7 are made of non-woven fabric. All of the inner cloth 11, the outer cloth 13, and the filter 12 constituting the front cover (main body) 10, including the upper rear cover 21 and the lower rear cover 22 are made of non-woven fabric. When all of the mask materials are made of non-woven fabric like this, the mask is manufactured by a high-frequency heating method instead of a sewing method. It is because the high-frequency heating method has much better workability than the sewing method.

However, in the case of bonding the metal microfiber cloth 15 in a mask made of a non-woven fabric material, a high frequency bonding method cannot be used, because when high frequency contacts the metal fabric and sparks, it may cause a fire. Therefore, in the case of fixing the metal microfiber cloth 15 in the outside of the outer cloth 13 or inside of the inner cloth 11, it must be fixed by the stitch 16, not high-frequency heating. When inserting the metal microfiber cloth 15 between the inner cloth 11 and the filter 12, or between the filter 12 and the outer cloth 13, there is no need to fix it separately. If you want to fix it, the metal microfiber cloth 15 should not be directly subjected to high-frequency heating, and the high-frequency heating should be performed along the periphery outside the metal microfiber cloth 15.

Since high-frequency heating is not possible in a mask made of a cotton fabric other than a non-woven fabric material, the metal microfiber cloth 15 is fixed by a stitch.

FIG. 8 is a schematic perspective view of a conventional cotton fabric mask manufactured by a sewing method using a cotton fabric, and FIG. 9 is a model diagram showing the configuration of the mask of FIG. 8. As illustrated in FIG. 9, the cotton fabric mask 50 consists of an inner cloth 51, a filter 52, and an outer cloth 53. The metal microfiber cloth 15 is inserted between the inner cloth 51 and the filter 52, or between the filter 52 and the outer cloth 53. In this case, the metal microfiber cloth 15 needs not to be fixed separately. If you want to fix it, the metal microfiber cloth 15 should not be directly subjected to high-frequency heating, and the high-frequency heating should be performed along the periphery outside the metal microfiber cloth 15. FIG. 10 is a schematic perspective view showing that the metal microfiber cloth 15 of the present invention is inserted into the mask of FIG. 8.

In a cotton fabric mask, the metal microfiber cloth 15 may be fixed outside the outer cloth 53 or inside the inner cloth 51. In this case, it should be fixed by the stitch 54, not by high-frequency heating. FIG. 11 shows that the metal microfiber cloth 15 of the present invention is fixed to the mask inner cloth 51 of FIG. 8 by a stitch 54.

The present invention uses a metal microfiber cloth for a mask woven with microfiber made from metal such as copper or silver to impart excellent antibacterial and sterilization functions to a conventional mask, and the bacterial growth in the mask cloth due to moisture when wearing the mask may be prevented, therefore the mask can be used up to 1 to 2 weeks, not necessarily used in a disposable way. The present invention provides a mask having an excellent antibacterial or sterilizing function while maintaining a dustproof function.

Simple modifications or changes of the present invention can be easily implemented by those of ordinary skill in the art, and all such modifications or changes can be considered to be included in the scope of the present invention.

Explanation of the Numerals

| | |
|---|---|
| 10: front cover (main body) | 11: inner cloth |
| 12: filter | 13: outer cloth |
| 15: metal microfiber cloth | 16: stitch |
| 21: upper rear cover | 22: lower rear cover |
| 30: ear string | 40: metal wire |
| 41: high-frequency heating | 50: cotton fabric mask |
| 51: inner cloth | 52: filter |
| 53: outer cloth | 54: stitch |

What is claimed is:

1. A non-woven cloth mask having a dustproof and antibacterial function, the mask comprising a front cover 10, an upper rear cover 21 which is foldably attached to the upper edge of the front cover, a lower rear cover 22 which is foldably attached to the lower edge of the front cover, and a pair of ear strings 30 which are attached to the side edges of the front cover, wherein the front cover comprises an inner cloth 11, an outer cloth 13, and a filter cloth 12 inserted between the cloths 11 and 13, wherein the mask further comprises at least one metal microfiber cloth 15 which is inserted between the inner cloth 11 and the filter cloth 12 or between the outer cloth 13 and the filter cloth 12, or attached to the inner surface of the inner cloth 11 or to the outer surface of the outer cloth 13.

2. The mask according to claim 1, wherein the metal microfiber cloth 15 is a plain weave fabric which is woven with a metal filament having a diameter of about 20 to 200 μm, wherein the number of filaments per one square inch is about 100 to 300, and wherein the metal is selected from the group consisting of silver, silver alloy, copper and copper alloy.

3. The mask according to claim 2, wherein the metal microfiber cloth has a size of about 50 to 70% of the surface of the front cover 10.

4. The mask according to claim 3, wherein the metal microfiber cloth 15 has a width of about 7 to 12 cm and a length of about 4 to 6 cm.

5. The mask according to claim 1, wherein the metal microfiber cloth 15 is fixed to the front cover 10 by stitching.

6. The mask according to any one of claims 1 to 5, wherein a wire is inserted into the upper part of the upper rear cover 21 and fixed by high-frequency heating 41.

7. A cotton cloth mask having a dustproof and antibacterial function, the mask comprising an inner cloth 51, an outer cloth 53, and a filter cloth 52 inserted between the cloths 51 and 53, wherein the mask further comprises at least one metal microfiber cloth 15 which is inserted between the inner cloth 51 and the filter cloth 52 or between the outer cloth 53 and the filter cloth 52, or attached to the inner surface of the inner cloth 51 or to the outer surface of the outer cloth 53.

8. The mask according to claim 7, wherein the metal microfiber cloth 15 is a plain weave fabric which is woven with a metal filament having a diameter of about 20 to 200 μm, wherein the number of filaments per one square inch is about 100 to 300, and wherein the metal is selected from the group consisting of silver, silver alloy, copper and copper alloy.

9. The mask according to claim 8, wherein the metal microfiber cloth 15 has a size of about 50 to 70% of the surface of the front cover 10.

10. The mask according to claim 9, wherein the metal microfiber cloth 15 has a width of about 7 to 12 cm and a length of about 4 to 6 cm.

11. The mask according to claim 7, wherein the metal microfiber cloth is fixed to the front cover 10 by stitching 54.

12. The mask according to any one of claims 7 to 11, wherein a wire is inserted into the upper part between the inner cloth 51 and the outer cloth 53 and fixed by stitching.
